(19) United States
(12) Patent Application Publication
(10) Pub. No.: US 2010/0157175 A1
(43) Pub. Date: Jun. 24, 2010

(54) VIDEO PROJECTOR

(75) Inventors: So SUZUKI, Osaka-shi (JP); Bumjin SHIN, Yao-shi (JP)

Correspondence Address: NOVAK DRUCE + QUIGG LLP, 1300 EYE STREET NW, SUITE 1000 WEST TOWER, WASHINGTON, DC, 20005, US

(73) Assignee: SANYO ELECTRIC CO., LTD., Osaka (JP)

(21) Appl. No.: 12/643,836

(22) Filed: Dec. 21, 2009

(30) Foreign Application Priority Data
Dec. 22, 2008 (JP) 2008-326248

(51) Int. Cl. H04N 5/64

(52) U.S. Cl. 348/789; 348/E05.128

(57) ABSTRACT

A video projector has a housing, with front and side walls, and a projection lens arranged in the front wall. A carrying handle is fastened to the housing to allow the video projector to be hand carried. The housing includes a sloped wall formed between at least one of the side walls and the front wall. The sloped wall extends diagonally relative to the front wall and at least one of the side walls. The carrying handle has a grip extending along a hypothetical intersecting line of an extended plane of the front wall and an extended plane of at least one of the side walls. The carrying handle and the sloped wall define an opening into which the hand of a person gripping the carrying handle is insertable.

### CROSS-REFERENCE TO RELATED APPLICATIONS

This application is based upon and claims the benefit of priority from prior Japanese Patent Application No. 2008-326248, filed on Dec. 22, 2008, the entire contents of which are incorporated herein by reference.

### BACKGROUND OF THE INVENTION

The present invention relates to a video projector, and more particularly, to a video projector including a carrying handle.

A projector modulates light, which is emitted from a light source, in accordance with light information to form an optical image. The projector then enlarges and displays the optical image on a large screen. Such a projector includes a housing, which houses optical devices, such as the projection lens, and electronic components. The housing of the projector is typically a substantially rectangular cuboid, the height of which is less than either the width or length.

To reduce the size of the substantially rectangular cuboid housing, the projection lens is arranged in the front wall of the housing so as to project outward from the housing. There are cases in which the projection lens is arranged in the projector in the middle of the front wall so that the projector can be easily installed, or suspended, from a ceiling. When the projection lens is arranged in the middle of the front wall, a center line of the housing is aligned with the center line of the projection lens. This facilitates positioning of the projector during installation when aligning the center line of the projection lens with the center line of the screen.

FIG. 8 shows a conventional projector disclosed in Japanese Patent No. 3467561. The conventional projector includes a housing 101. The housing 101 is a substantially rectangular cuboid, the height of which is less than either the width or length. The housing 101 includes a relatively narrow front wall 103 and a relatively wide side wall 105. A projection lens 102 projects from the front at the middle of the front wall 103. A retractable carrying handle 104 is arranged in the middle of the side wall 105. More specifically, the side wall 105 at middle positions in the heightwise direction rotatably supports the carrying handle 104, which includes two basal portions 104a and 104b. The side wall 105 includes a retaining recess 106 to receive the carrying handle 104.

### SUMMARY OF THE INVENTION

In the conventional projector, the carrying handle 104 is arranged in the middle of the side wall 105. Thus, when the projector is carried, the projection lens 102 is directed toward the front or rear relative to the carrying person. As a result, the projection lens 102 is susceptible to being damaged when the projector is being carried.

It is an object of the present invention to provide a video projector that avoids damaging of the projection lens when the projector is carried, while including a carrying handle that does not reduce interior space in the housing that is used to accommodate devices.

One aspect of the present invention is a video projector provided with a housing including a front wall and a plurality of side walls. A projection lens is arranged in the front wall so as to project outward from the housing. A carrying handle is fastened to the housing. The carrying handle cooperates with the housing to form the shape of a substantially rectangular cuboid. The housing includes a sloped wall formed between at least one of the side walls and the front wall, upper projecting rims, each formed integrally with either one of the front wall and the at least one of the side walls, and lower projecting rims, each formed integrally with either one of the front wall and the at least one of the side walls. The sloped wall extends diagonally relative to the front wall and the at least one of the side walls. The upper projecting rims and the lower projecting rims extend toward ends of the carrying handle. The carrying handle includes a grip extending along a hypothetical intersecting line of a plane extending from the front wall and a plane extending from the at least one of the side walls. The upper projecting rims, the lower projecting rims, the carrying handle, and the sloped wall define an opening into which a hand of a person gripping the carrying handle is insertable.

One embodiment of the present invention provides a video projector provided with a housing including a front wall, two opposing side walls, and two sloped walls formed between each of the two side walls and the front wall. Each of the sloped walls extend diagonally relative to the front wall and the two side walls. A projection lens project outward from the front wall of the housing. Two carrying handles respectively face toward the two sloped walls. The two carrying handles cooperate with the housing to form the shape of a substantially rectangular cuboid. The two carrying handles respectively extend along two parallel edges of the substantially rectangular cuboid. Each of the carrying handles is spaced from the corresponding sloped wall to define in between an opening into which a hand of a person may be inserted to grip the carrying handle.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a video projector according to one embodiment of the present invention;

FIG. 2 is an exploded perspective view showing a carrying handle fastening portion of the video projector of FIG. 1;

FIGS. 3 and 4 are exploded perspective views showing the carrying handle of the video projector of FIG. 1;

FIG. 5 is a cross-sectional view taken along line V-V in FIG. 6; FIG. 6 is a cross-sectional view taken along line VI-VI in FIG. 5;

FIG. 7(a) shows the video projector being carried by one person;

FIG. 7(b) shows the video projector being carried by two persons; and

FIG. 8 is a perspective view showing a prior art video projector.

### DETAILED DESCRIPTION OF THE PREFERRED EMBODIMENTS

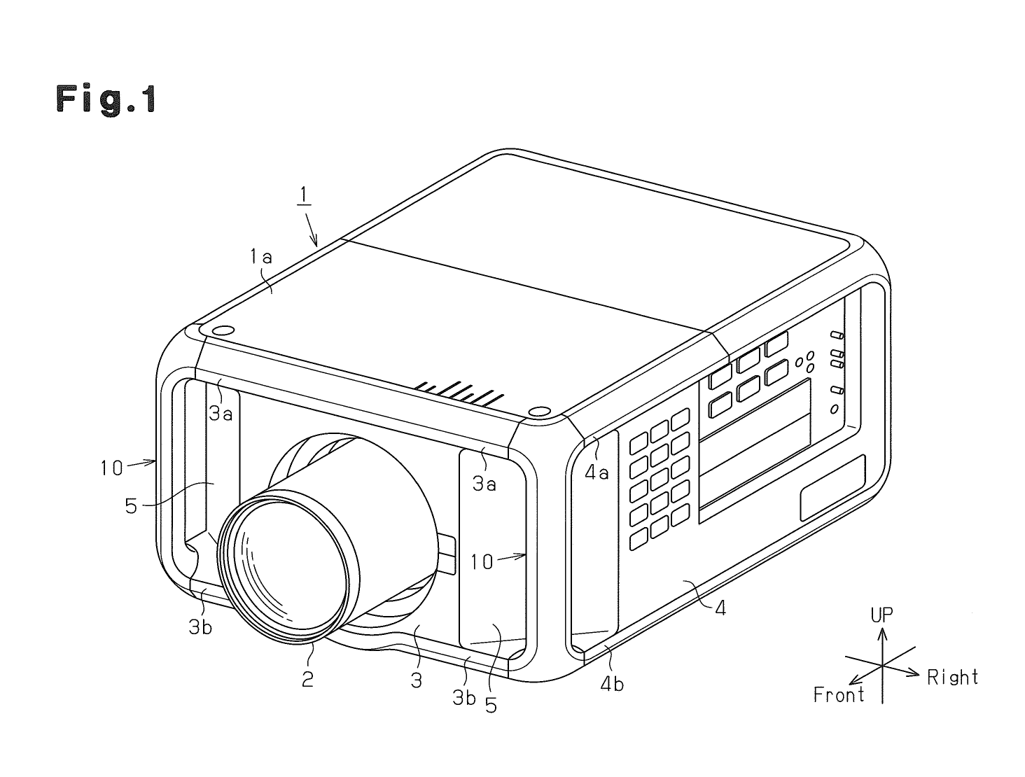

In this specification, the terms “front surface” and “front wall” refer to the surface of a video projector on which a projection lens is arranged (refer to FIG. 1). The frame of reference for the terms “up” and “down” is a state in which the projector is horizontally set. A projector is normally set so that its largest surface faces downward.

A video projector according to one embodiment of the present invention will now be discussed. As shown in FIG. 1, the video projector includes a housing 1, which houses optical devices and electronic components, and a projection lens 2, which projects outward from a middle part of a front wall 3 of the housing 1. A carrying handle 10 may be arranged in one or both of left and right edges of the front wall 3 of the housing 1.

In the illustrated example, the housing 1 is a substantially rectangular cuboid including portions formed by chamfering edges, which connect adjacent sides. More specifically, the housing 1, the height of which is less than either the width or length, includes a front wall 3, two opposing side walls 4, and two sloped walls 5 diagonally connecting the front wall 3 and the side walls 4. The sloped walls 5 are also referred to as chamfered surfaces. Each carrying handle 10 faces toward a corresponding one of the sloped walls 5. Each carrying handle 10 extends along a hypothetical intersecting line of a plane (extended plane) extending from the front wall 3 and a plane (extended plane) extending from the corresponding side wall 4, i.e., a vertically-extended edge of the substantially rectangular cuboid.

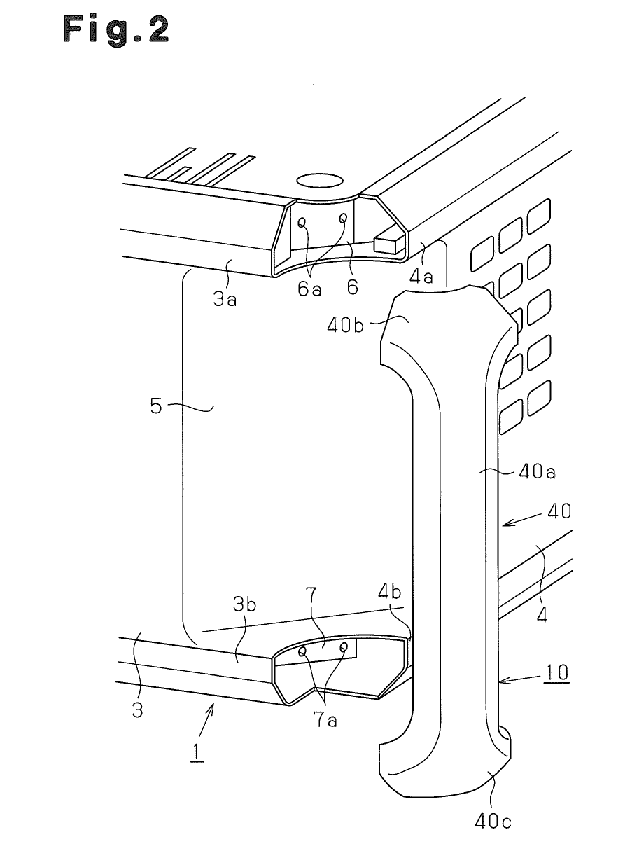

As shown in FIG. 2, the front wall 3 has an upper portion and a lower portion in which an upper projecting rim 3a and a lower projecting rim 3b are respectively formed. The upper and lower projecting rims 3a and 3b project outward from the ends of the sloped walls 5 so as to be flush with the carrying handles 10.

Each side wall 4 has an upper portion and a lower portion in which an upper projecting rim 4a and a lower projecting rim 4b are respectively formed. The upper and lower projecting rims 4a and 4b project outward from the end of the corresponding sloped wall 5 so as to be flush with the corresponding carrying handles 10.

Flat fastening plates 6 and 7 for fastening the carrying handle 10 are arranged at the upper and lower sides of each side wall 4 in the housing 1. The fastening plates 6 and 7 may be part of a reinforcement member attached to an upper plate 1a (FIG. 1) and lower plate of the housing 1 or be fixed to such a reinforcement member. The fastening plates 6 and 7 respectively include insertion holes 6a and 7a, which receive screws used to fasten the carrying handle 10 to the fastening plates 6 and 7.

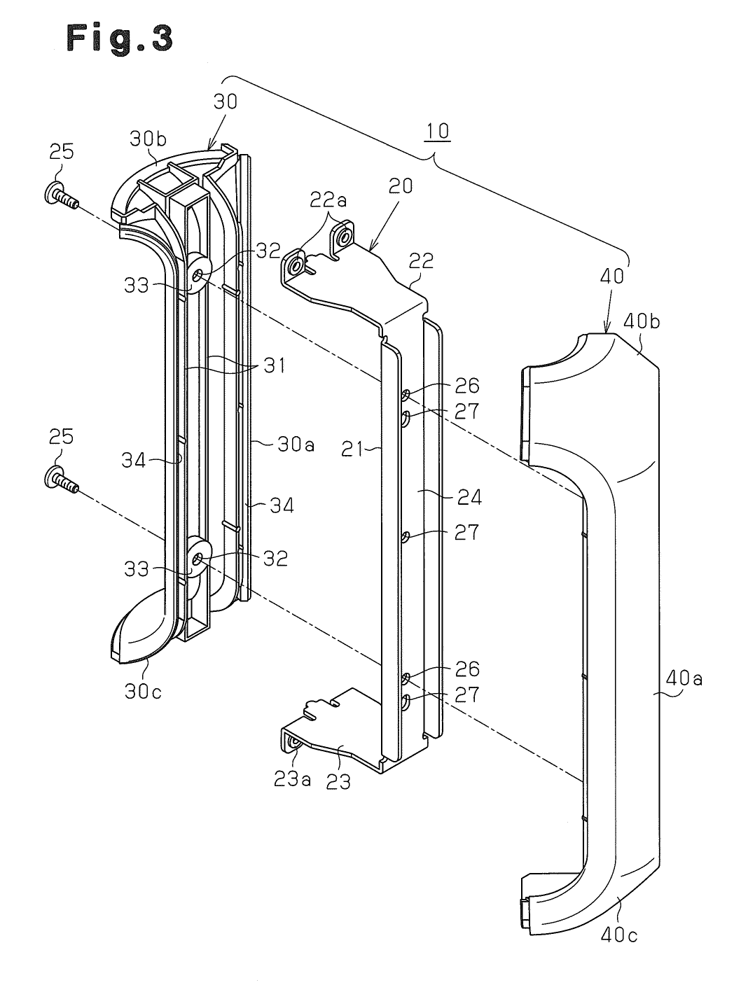

Referring to FIGS. 3 and 4, the carrying handle 10 has an elongated shape and includes a metal base 20, an inner cover 30, and an outer cover 40. The metal base 20 is fastened to the fastening plates 6 and 7. The inner cover 30 is attached to the inner surface of the metal base 20 facing toward the corresponding sloped wall 5. The outer cover 40 is attached to the outer surface of the metal base 20. The inner cover 30 and the outer cover 40 may be formed from plastic.

The metal base 20 includes an elongated main body 21 and arms 22 and 23, which are respectively formed by bending the upper and lower portions of the main body 21. Referring to FIG. 3, the main body 21 is gutter-shaped or trough-shaped and includes a flat portion 24 and two side plates. The flat portion 24 includes two insertion holes 26, which receive screws 25, and three pin holes 27, which receive positioning pins 41 that extend from the outer cover 40.

The carrying handle 10 is fastened to the housing 1 by screws (not shown), which are inserted through the insertion holes 6a and 7a of the fastening plates 6 and 7 from the inner side of the housing 1 and mated with threaded holes 22a and 23a formed in the metal base 20. The fastening of the carrying handle 10 is performed in a state in which the upper plate 1a (refer to FIG. 1) and lower plate are removed from the housing 1.

The inner cover 30 includes a main body cover portion 30a, which covers the main body 21 of the metal base 20, and arm covers 30b and 30c, which respectively cover the arms 22 and 23. To cover the main body 21, the main body cover portion 30a is fitted into the space between the arms 22 and 23 of the metal base 20. The main body cover portion 30a includes two ribs 31, which come into contact with the flat portion 24 of the main body 21. As shown in FIG. 4, the inner cover 30 includes recesses 33 formed in the outer surface that faces toward the sloped wall 5. An insertion hole 32 extends from each recess 33. As shown in FIGS. 3 to 6, each recess 33 is cylindrical and has a bottom portion from which the insertion hole 32 extends. The head of a screw 25 is retained in the recess 33 so that the head does not project out of the inner cover 30.

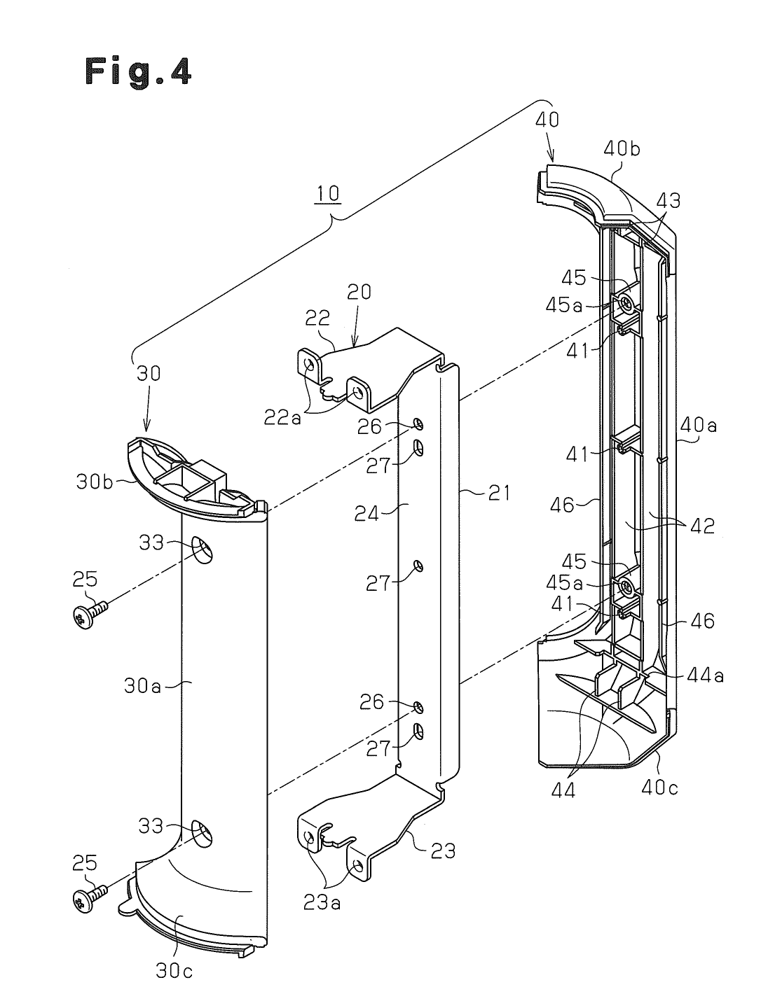

Referring to FIGS. 4 and 5, the outer surface of the inner cover 30 that faces toward the sloped wall 5 is smoothly curved so that it has a comfortable feel when the carrying handle 10 is gripped by a person. The arm cover portion 30b includes lateral edges that come into contact with the edges of the upper projecting rims 3a and 4a of the housing 1. The arm cover portion 30c includes lateral edges that come into contact with the edges of the lower projecting rims 3b and 4b of the housing 1. The arm cover portions 30b and 30c of the inner cover 30 connect smoothly to the upper projecting rims 3a and 4a and the lower projecting rims 3b and 4b. The inner cover 30 appears as if it is formed integrally with the housing 1. An engagement groove 34 extends vertically in each of the two sides of the inner cover 30.

The outer cover 40 includes a main body cover portion 40a, which covers the main body 21 of the metal base 20, and arm covers 40b and 40c, which respectively cover the arms 22 and 23. The main body cover portion 40a includes three positioning pins 41, which are used to position the metal base 20 to the outer cover 40. The outer cover 40 further includes two vertically extending ribs 42, which support the flat portion 24 of the metal base 20, upper and lower restriction walls 43 and 44, which respectively come into contact with the arms 22 and 23 of the metal base 20, and restriction walls 43a and 44a (refer to FIGS. 4 and 6), which restrict lateral displacement of the metal base 20. Screw seats 45, each including a threaded hole 45a that is mated with the corresponding screw 25, project from the main body cover portion 40a between the two ribs 42. An engagement rib 46 extends vertically in each of the two sides of the outer cover 40. The two engagement ribs 46 engage with the corresponding engagement grooves 34 of the inner cover 30.

As shown in FIGS. 1 and 2, the arm cover portion 40b includes lateral edges that come into contact with the edges of the upper projecting rims 3a and 4a of the housing 1. The arm cover portion 40c includes lateral edges that come into contact with the edges of the lower projecting rims 3b and 4b of the housing 1. The arm cover portions 40b and 40c of the outer cover 40 connect smoothly to the upper projecting rims 3a and 4a and the lower projecting rims 3b and 4b. The outer cover 40 appears as if it is formed integrally with the housing 1.

The arm cover portions 30b, 30c, 40b, and 40c of the inner cover 30 and the outer cover 40 are designed so that the carrying handle 10 and the housing 1 have an overall shape of a substantially rectangular cuboid. The main body covers 30a and 40a of the inner cover 30 and outer cover 40 and the main body 21 of the metal base 20 function as a grip of the carrying handle 10.

When the carrying handle 10 is fastened to the housing 1, an opening or passage is defined between the housing 1 and the grip of the carrying handle 10. More specifically, an opening or passage is defined between the carrying handle 10 and the front wall 3, the carrying handle 10 and the side wall 4, and the carrying handle 10 and the sloped wall 5. The opening allows for insertion of a person's fingers from the side wall 4 and front wall 3 of the housing 1. The opening has dimensions that are set to allow for inserted fingers to clutch the grip.

The assembly of the carrying handle 10 will now be discussed. First, the metal base 20 is arranged on the inner surface of the outer cover 40, and the positioning pins 41 of the outer cover 40 are inserted into the pin holes 27 of the metal base 20. As a result, the upper and lower ends of the main body 21 in the metal base 20 respectively come into contact with the restriction walls 43 and 44 of the outer cover 40, and the lateral sides of the main body 21 respectively come into contact with the restriction walls 43a and 44a of the outer cover 40. This restricts relative movement between the metal base 20 and the outer cover 40. Then, the metal base 20 is covered with the inner cover 30 so that the engagement grooves 34 of the inner cover 30 engage with the engagement ribs 46 of the outer cover 40. As a result, when the metal base 20 is held in the inner cover 30 at a predetermined position, the insertion holes 26 of the metal base 20 are aligned with the threaded holes 45a of the outer cover 40. Then, two screws 25 are inserted through the insertion holes 32 of the inner cover 30 and mated with the threaded holes 45a of the outer cover 40 to hold the metal base 20 between the ribs 31 of the inner cover 30 and the ribs 42 of the outer cover 40. This completes the assembly of the carrying handle 10.

The fastening of the carrying handle 10 to the housing 1 will now be discussed. First, the upper plate 1a and lower plate are removed from the housing 1. Then, screws are inserted into the insertion holes 6a and 7a from the inner side of the housing 1 and mated with the threaded holes 22a and 23a of the assembled carrying handle 10. In this manner, the carrying handle 10 is fastened to the housing 1. Afterwards, the upper plate la and lower plate are attached to the housing 1. This completes the fastening of the carrying handle 10 to the housing 1. As shown in FIG. 1, the carrying handles 10 appear as if they are part of the housing 1. Further, the carrying handles 10 are spaced from the front wall 3 leftward and rightward from the projection lens 2. This structure forms an opening or passage, which is used to hold the carrying handle 10, between the grip of each carrying handle 10 and the corresponding side wall 4 and between the grip and the corresponding sloped wall 5 of the housing 1.

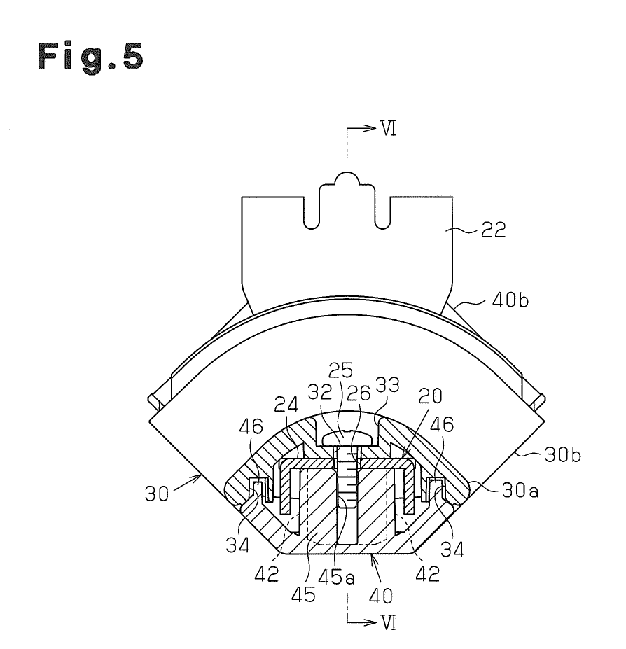

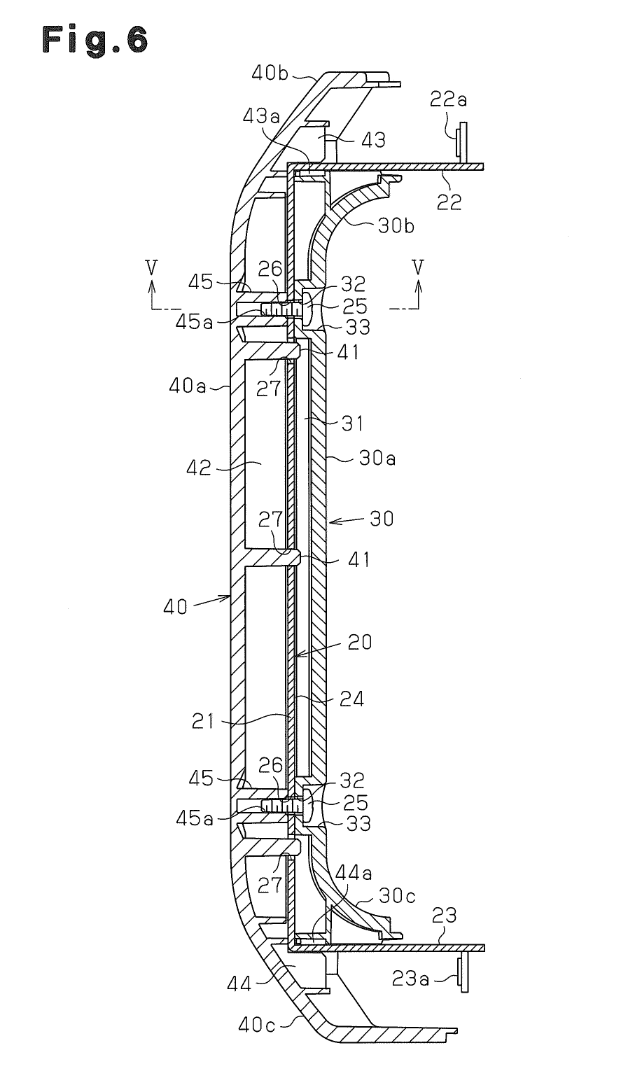

A person may hold a carrying handle 10 with his or her hand to carry the video projector of this embodiment. As shown in FIG. 7(a), when only one person 8 is carrying the video projector, the person 8 may carry the video projector with one hand. As shown in FIG. 7(b), when there are two persons 8, each person 8 may hold one of the carrying handles 10 with one hand to carry the video projector. Further, one person 8 may hold both carrying handles 10 with both hands. In any case, the person 8 holds the video projector near his or her body with the projection lens 2 facing upward. The projection lens 102 is not directed toward the front or rear relative to the person 8. This prevents damaging of the projection lens 2 when the video projector is carried.

The video projector of one embodiment has the advantages described below.

(1) The housing 1 includes a front wall 3 from which the projection lens 2 projects. The carrying handle 10 is arranged in one or both edges of the front wall 3 of the housing 1. Accordingly, when holding the carrying handle 10, the projection lens 2 faces in an upward direction and near the body of the person 8 who is carrying the video projector. This prevents damaging of the projection lens 2. Further, the carrying handles 10 are arranged at positions located sideward from the front wall 3. Thus, the interior space for housing devices in the housing 1 is not narrowed by the carrying handles 10.

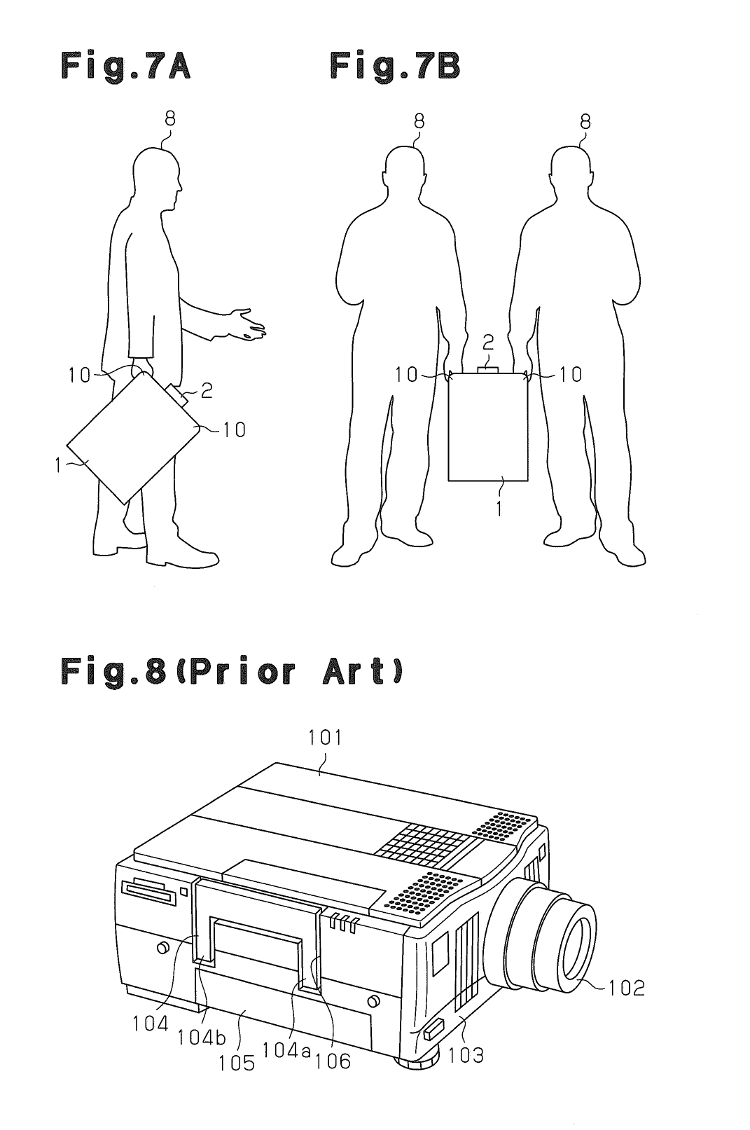

(2) The two carrying handles 10 are arranged at intersections of an extended plane of the front wall 3 and extended planes of the side walls 4. Thus, the video projector may be carried by two persons 8. This also allows for one person 8 to firmly hold and carry the video projector with both hands. This eases the carrying of the video projector. In contrast, the conventional projector (refer to FIG. 8) includes only one carrying handle, which is arranged in a side wall. Thus, it is difficult for two persons to carry the conventional projector.

(3) The carrying handle 10 includes the metal base 20, which is attached to reinforcement members formed on the upper and lower surfaces of the housing 1, the inner cover 30, which is formed from a resin or plastic and attached to the inner surface of the metal base 20, and the outer cover 40, which is formed from a resin or plastic and attached to the outer surface of the metal base 20. Accordingly, the carrying handle 10 has a predetermined strength, and the inner cover 30 and outer cover 40 improve the appearance of the carrying handle 10.

(4) The upper projecting rims 3a and 4a and the lower projecting rims 3b and 4b extend from the upper and lower portions of the front wall 3 and the side walls 4 so as to be flush with the ends of the carrying handles 10. Further, the inner cover 30 and the outer cover 40 are shaped to connect smoothly the upper projecting rims 3a and 4a and the lower projecting rims 3b and 4b. Thus, the carrying handles 10 appear as if they are part of the housing 1. This improves the appearance of the video projector.

(5) The inner cover 30 and the outer cover 40 respectively include ribs 31 and 42, which hold the metal base 20. This increases the rigidity of the inner cover 30 and the outer cover 40, and the carrying handles 10 are not damaged by a gripping force.

(6) The outer surface of the inner cover 30, which faces toward the sloped surface, is smoothly curved. Thus, a sharp edge is not applied to the hand gripping the carrying handle 10, and the hand may comfortably grip the carrying handle 10.

(7) The head of each screw 25, which is used to assemble the carrying handle 10, is retained in the recess 33, from which the insertion hole 32 that receives the screw 25 in the inner cover 30 extends. This hides the screw 25 and improves the appearance of the video projector. Further, the hand gripping the carrying handles 10 is not hurt by the head of the screw 25.

(8) When the metal base 20 is arranged on the outer cover 40, inside the outer cover 40, the positioning pins 41, the ribs 42, the restriction walls 43 and 44, which are for restricting the upper and lower ends, and the restriction walls 43 and 44, which are for restricting left and right sides, determine the position of the outer cover 40 relative to the metal base 20. Then, when the inner cover 30 is joined with the outer cover 40 to hold the metal base 20, the threaded holes 45a arranged in the screw seats 45 of the outer cover 40 are aligned with the insertion holes 26 and 32 of the metal base 20 and the inner cover 30. This facilitates the fastening of the carrying handle 10 to the housing 1. When the inner cover 30 and outer cover 40 are joined with each other, the engagement grooves 34 engage with the engagement ribs 46, and the inner cover 30 and outer cover 40 are joined with each other at predetermined positions.

It should be apparent to those skilled in the art that the present invention may be embodied in many other specific forms without departing from the spirit or scope of the invention. Particularly, it should be understood that the present invention may be embodied in the following forms.

In the above described and illustrated embodiment, the two carrying handles 10 are arranged along hypothetical intersecting lines of an extended plane of the front wall 3 and extended planes of the corresponding side walls 4. However, the video projector may have only one carrying handle 10. In this case, the single carrying handle 10 is arranged along a hypothetical intersecting line of an extended plane of the front wall 3 and an extended plane of one of the side walls 4.

The opening or passage of the carrying handle 10 may be used as a slot for receiving an antitheft cable. In this case, the antitheft cable may be horizontally inserted into the opening. Thus, the antitheft cable may be attached to the video projector without any interference between the antitheft cable and the surface on which the video projector is set.

The type of the video projector is not limited. For example, the video projector may be a three-panel type LCD projector or a digital micromirror device (DMD) projector.

The fastening of the carrying handle 10 to the housing 1 is not limited to the mating of the screws with the carrying handle 10 from the inner side of the housing 1. For example, the carrying handle 10 may be fastened by first forming a window in part of the upper plate la or the lower plate. Screws are inserted into the arm 22 or 23 of the metal base 20, with the distal end of each screw facing toward the housing. The distal ends of the screws are then inserted into the insertion holes 6a of the fastening plate 6 or the insertion holes 7a of the fastening plate 7. Then, the window is used to fasten nuts to the distal ends of the screws. In this case, after assembling the housing 1, the carrying handle 10 may be fastened to the housing 1.

The video projector includes a device, such as an adjustor, secured to a cable used to suspend the video projector from a ceiling and prevent the video projector from falling down. The carrying handle 10 may be used as such a device that is secured to a cable. In such a case, one end of the cable is inserted into the opening of the carrying handle 10 and tied to the carrying handle 10.

The present examples and embodiments are to be considered as illustrative and not restrictive, and the invention is not to be limited to the details given herein, but may be modified within the scope and equivalence of the appended claims.

What is claimed is:

1. A video projector, comprising:
a housing including a front wall and a plurality of side walls;
a projection lens arranged at a middle part of the front wall so as to project outward from the housing; and
a carrying handle fastened to the housing;
wherein the carrying handle cooperates with the housing to form the shape of a substantially rectangular cuboid;
the housing includes:
a sloped wall formed between at least one of the side walls and the front wall; and
upper projecting rims, each formed integrally with either one of the front wall and the at least one of the side walls, and lower projecting rims, each formed integrally with either one of the front wall and the at least one of the side walls;
wherein the sloped wall extends diagonally relative to the front wall and the at least one of the side walls; and
the upper projecting rims and the lower projecting rims extend toward ends of the carrying handle; and
the carrying handle includes a grip extending along a hypothetical intersecting line of an extended plane of the front wall and an extended plane of the at least one of the side walls; and
wherein the upper projecting rims, the lower projecting rims, the carrying handle, and the sloped wall define an opening into which a hand of a person gripping the carrying handle is insertable.

2. The video projector according to claim 1, wherein the sloped wall is one of a plurality of sloped walls formed between the front wall and the plurality of side walls; and
the carrying handle is one of a plurality of carrying handles each facing toward a corresponding one of the sloped walls.

3. The video projector according to claim 1, wherein the carrying handle includes:
a metal base fastened to upper and lower fastening plates arranged on the housing, the metal base including an inner surface facing the sloped wall and an outer surface arranged opposite to the inner surface;
an inner cover attached to the inner surface of the metal base; and
an outer cover attached to the outer surface of the metal base.

4. The video projector according to claim 3, wherein:
the upper projecting rims and the lower projecting rims extend along edges of the substantially rectangular cuboid; and
the inner cover and the outer cover are formed so as to:
smoothly connect the upper projecting rim of the front wall and the upper projecting rim of the at least one of the side walls;
smoothly connect the lower projecting rim of the front wall and the lower projecting rim of the at least one of the side walls;
smoothly connect the upper projecting rim and lower projecting rim of the front wall; and
smoothly connect the upper projecting rim and lower projecting rim of the at least one of the side walls.

5. The video projector according to claim 3, wherein the inner cover and the outer cover each include a plurality of ribs extending in a longitudinal direction of the carrying handle, and wherein the metal base is held between the ribs of the inner cover and the ribs of the outer cover.

6. The video projector according to claim 3, wherein the inner cover includes a smoothly curved outer surface facing toward the sloped wall.

7. The video projector according to claim 3, wherein:
the inner cover includes a recess, which receives a screw, with an insertion hole extending from the recess;
wherein a distal end of the screw is inserted into the insertion hole from an outer side of the inner cover and mated through the metal base with a threaded hole formed in the outer cover; and
a head of the screw is retained in the recess of the inner cover without projecting from the inner cover.

8. The video projector according to claim 7, wherein:
the metal base includes a pin hole, upper and lower ends, and left and right ends;
the outer cover includes a positioning pin, which corresponds to the pin hole, and a plurality of restriction walls, which come into contact with the upper and lower ends and left and right ends of the metal base, wherein the positioning pin and the restriction walls position the metal base, which is joined with the outer cover.

9. A video projector comprising:
a housing including a front wall, two opposing side walls, and two sloped walls formed between each of the two side walls and the front wall, with each of the sloped walls extending diagonally relative to the front wall and the two side walls;
a projection lens projecting outward from the front wall of the housing; and
two carrying handles respectively facing toward the two sloped walls;
wherein the two carrying handles cooperate with the housing to form the shape of a substantially rectangular cuboid, wherein the two carrying handles respectively extend along two parallel edges of the substantially rectangular cuboid;
each of the carrying handles is spaced from the corresponding sloped wall to define in between an opening into which a hand of a person may be inserted to grip the carrying handle.

10. The video projector according to claim 9, wherein each of the carrying handles is arranged on a plane extending sideways from the front wall.

11. The video projector according to claim 10, wherein the two carrying handles occupy the two parallel edges and four corners in a front rectangular plane of the substantially rectangular cuboid.

12. The video projector according to claim 11, wherein the two carrying handles are parallel to each other.

13. The video projector according to claim 12, wherein each of the carrying handles is nonretractable and is rigidly fixed to the housing.

14. The video projector according to claim 13, wherein each of the carrying handles includes a grip having a curved surface that smoothly bulges toward the corresponding sloped wall.

15. The video projector according to claim 9, wherein each of the sloped walls is a flat surface.

16. The video projector according to claim 9, wherein the front wall, the projection lens, and the two carrying handles are exposed from the same side of the video projector.
